(19) United States
(12) Patent Application Publication
(10) Pub. No.: US 2002/0128931 A1
(43) Pub. Date: Sep. 12, 2002

(54) Apparatus, method and computer program product for creating and using a priced object

(75) Inventors: Benjamin Andrew Himmel, Yorktwon Heights, NY (US); Maria Azua Himmel, Yorktown Heights, NY (US); Herman Rodriguez, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/801,615

(22) Filed: Mar. 8, 2001

(51) Int. Cl. G06F 17/60

(52) U.S. Cl. 705/27

(57) ABSTRACT

An apparatus, method and computer program product for creating and using a priced object are provided. The priced object according to the present invention may include an item identifier, offer terms for the sale of the item, an identifier of the goods/services provider that is making the offer, and authentication information for authenticating the priced object. The priced object may be generated and stored for later use by a client device when performing on-line shopping with another goods/services provider. The other goods/services provider may authenticate the priced object to verify that the priced object is not fraudulent and may then make determinations as to whether to meet or beat the terms of the offer described in the priced object. If the other goods/services provider decides to meet or beat the offer provided in the priced object, the client device may request a new priced object with the other goods/services provider's new offer terms.

### BACKGROUND OF THE INVENTION

1. Technical Field:

The present invention is directed to an apparatus, method, and computer program product for creating and using a priced object. More specifically, the present invention is direct to an apparatus, method and computer program product for generating a data object to be used in offer terms comparison of offers on goods/services made by goods/services providers in a network data processing system.

2. Description of Related Art:

The Internet is fast becoming a principal marketplace by which business sell their products to a vast, and ever increasing, consumer base. Users of the Internet may access Web sites and Web pages of various goods/services providers by entering a Uniform Resource Locator (URL) for the Web site in a Web browser application resident on their client computers. The users may then shop for items by viewing one or more Web pages, representing an electronic catalog of goods and/or services, and selecting items that they are interested in purchasing. The user may then enter information into an electronic form in order to complete their on-line purchase.

While a user may shop on-line for an item and visit many different business Web sites to identify the goods/services provider that provides the best deal on an item of interest, this requires a great deal of time and effort on the part of the user. Furthermore, there currently is not mechanism by which a user may inform one electronic business (e-business) of the offers being made by another e-business. In other words, there is no mechanism by which a user can cause e-businesses to price match or beat the prices offered by other e-businesses. Thus, it would be beneficial to have an apparatus, method and computer program product for providing a mechanism to facilitate competition between e-businesses for the business of an on-line consumer.

It would therefore, be beneficial to have an apparatus, method and computer program product for providing a mechanism to inform e-businesses of the offers being made by other e-businesses on the same items in a manner that is verifiable by the e-businesses so that the e-business may perform price matching or beat the price of other e-businesses on the same item.

### SUMMARY OF THE INVENTION

The present invention provides an apparatus, method and computer program product for creating and using a priced object. The priced object according to the present invention may include an item identifier, offer terms for the sale of the item, an identifier of the goods/services provider that is making the offer, and authentication information for authenticating the priced object. The priced object may be generated and stored for later use by a client device when performing on-line shopping with another goods/services provider. The other goods/services provider may authenticate the priced object to verify that the priced object is not fraudulent and may then make determinations as to whether to meet or beat the terms of the offer described in the priced object. If the other goods/services provider decides to meet or beat the offer provided in the priced object, the client device may request a new priced object with the other goods/services provider's new offer terms.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a network data processing system according to the present invention;

FIG. 2 is an exemplary block diagram of a data processing system according to the present invention;

FIG. 3 is an exemplary block diagram of a data processing system according to the present invention;

FIG. 4 is a diagram illustrating a data flow in accordance with the present invention;

FIG. 5 is a flowchart outlining an exemplary operation of the present invention when generating a priced object; and

FIG. 6 is a flowchart outlining an exemplary operation when using a priced object to perform price comparisons with goods/services providers.

### DETAILED DESCRIPTION OF THE PREFERRED EMBODIMENT

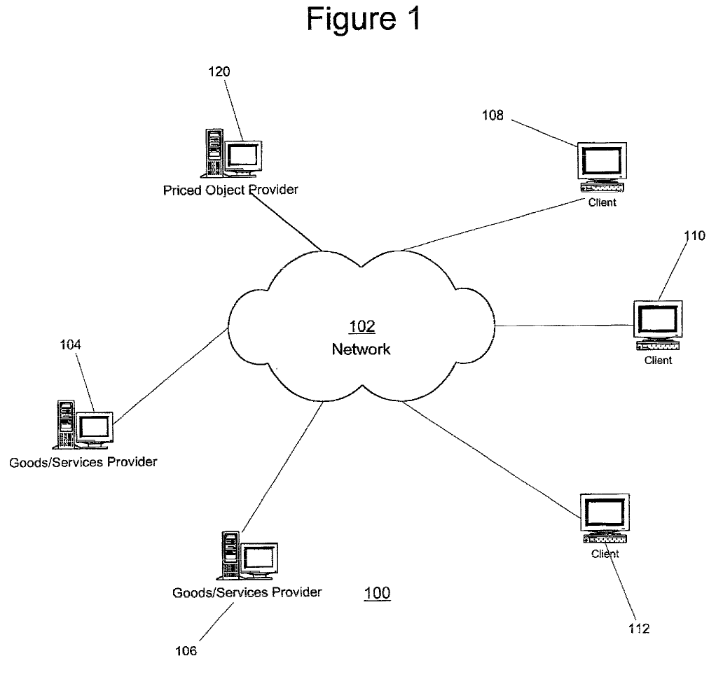

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, goods/services providers 104 and 106 are connected to network 102. The goods/services providers 104 and 106 may be, for example, electronic business (e-business) web site providers through which goods and/or services may be marketed. The goods/services providers 104 and 106 may be implemented, for example, on server devices, such that customers may access web pages, applets, and the like, resident on the goods/services providers 104 and 106 via the network 102. In addition, customers may purchase goods and/or services from the goods/services providers 104 and 106 by placing orders for goods/services using electronic forms, in a manner generally known in the art.

In addition to goods/services providers 104 and 106, clients 108, 110, and 112 also are connected to network 102. These clients 108, 110, and 112 may be, for example, personal computers or network computers. Clients 108, 110, and 112 are clients to goods/services providers 104 and 106 and as such, may obtain goods/services information from these providers as well as place orders for goods and/or services with these providers. Network data processing system 100 may include additional goods/services providers, servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

In addition to the goods/services providers 104-106 and clients 108-112, a priced object provider 120 is coupled to the network 102. The priced object provider 120 provides priced objects for goods/services of interest to users of client device 108-112. A priced object is data object that is able to be used by a user of a client device 108-112 to perform price shopping amongst the various goods/services providers 104-106. By using the priced object of the present invention, goods/services providers 104-106 must compete with one another for the business of the user, i.e. the potential customer.

The priced object provides a mechanism similar to a goods/services provider advertisement that can be provided to other goods/services providers in order to determine if the other goods/services provider is willing to match or beat the price advertised by the first goods/services provider. The priced object is an electronic data object that stores information pertaining to the particular good/service offered by one goods/services provider 104 or 106. In addition, the priced object stores authentication information for authenticating the priced object such that goods/services providers are assured that the priced object accurately reflects an offer made by another goods/services provider. An expiration date may further be provided in the priced object to thereby limit the amount of time that a priced object may be used.

With the present invention, when a user of a client device, such as client device 108, is shopping for goods/services over the network 102, the user will typically enter a Uniform Resource Locator (URL) for a Web site maintained by a goods/services provider, such as goods/services provider 104. The URL may be entered directly by the user via a web browser application on the client device, may be selected from a list of URLs, such as those returned based on a text search performed by a search engine, or the like.

In response to the user entering or selecting a URL for a Web page resident on goods/services provider 104, the Web page content is downloaded to the client device 108. Such Web pages may include, for example, identifiers of goods/services provided by the goods/services provider 104, for example. A user may then, through a user interface associated with the client device, select an item of interest, i.e. a good or service, from the Web page and request that a priced object be provided for that item.

The option to request a priced object may be provided by the goods/services provider 104 or may be provided through a functionality added to the web browser application of the client device. For example, a plug-in device may be provided to the client device's web browser application that may be used to request and/or store priced objects for items found on Internet Web pages. Alternatively, a hyperlink, applet, or the like, may be provided and downloaded to the client device 108 when the Web page is downloaded, or in response to a selection of an item from the Web page, through which a user of the client device 108 may select an option to request a priced object.

In response to receiving a request for a priced object, the plug-in of the goods/services provider 104 may transmit a priced object for the selected item to the client device 108. Alternatively, the priced object may be generated and stored in association with a client device identifier on the goods/services provider 104 or in the priced object provider 120. Moreover, in one embodiment of the present invention, the request for a priced object may be forwarded by the plug-in or the goods/services provider 104 to the priced object provider 120 which both generates or retrieves the priced object, and stores the priced object on the priced object provider 120 in association with a client device identifier.

Priced objects may be generated and stored a priori on the goods/services providers 104-106, the client device 108, or the priced object provider 120, for one or more of the items provided by the goods/services providers 104-106. Alternatively, these priced objects may be generated “on-the-fly” when requested by a client device.

Once a priced object is obtained for an item of interest, the user of the client device 108 may then “shop around” for better deals on that item using the priced object as proof of the deal offered by the first goods/services provider. If another goods/services provider offers the same item at different terms, the user of the client device 108 may transmit the priced object or inform the other goods/services provider of the existence of the priced object and where to obtain it. The other goods/services provider, after obtaining the priced object, may then choose whether to match, beat, or provide a different offer to the user of the client device 108 for that item. If the other goods/services provider chooses to match, beat or provide a different offer, the user of the client device 108 may request that a new priced object for the new offer be generated and the operation may be repeated.

In any of the above embodiments, the priced object is generated by storing one or more of a commonly recognized identifier of the item (such as a International Standard Book Number (ISBN), barcode, or the like), a price for the item (which may be inters of monetary units or a price code), an expiration date for the priced object, an identifier of the goods/services provider that has made the offer, and the like. In some applications, rather than the price, or in addition to the price, of the item, additional incentives offered by the goods/services provider 104 with regard to the item may be included in the priced object. For example, the priced object may include an indicator that a particular item has a mail-in rebate ($100.00 manufacturer's mail-in rebate), a percentage discount (10% off the price), a tied item that may be purchased at a reduced price (get a free watch with the purchase of this electronic organizer), or the like. In short, any elements of an offer of sale that may be used as a mechanism for bargaining between goods/services providers may be incorporated into the priced object without departing from the spirit and scope of the present invention.

In addition to the terms of the offer of sale of the item, the priced object may include authentication information for authenticating the offer of sale. Such authentication may include electronic certificates, encrypted data used for authentication (such as a merchant identifier), or the like. Alternatively, rather than, or in addition to, including authentication data within the priced object, encryption of the priced object using an encryption algorithm, such as private key/public key encryption, may be used to encrypt the priced object.

All of these measures are intended to provide assurances to the goods/services providers that the user has not himself generated the priced object. That is, these measures are used to minimize the possibility that fraudulent priced objects can be generated. Other mechanisms for assuring the security of the priced object may be used without departing from the spirit and scope of the present invention.

In addition, by centralizing the generation and storage of priced objects in a priced object provider 120, further assurances are provided that the priced object is an authentic priced object. With the use of a centralized price object provider 120, a client device 108 may contact a goods/services provider, find an item of interest for which a priced object already exists, and inform the goods/services provider that the client device 108 has a stored priced object for the item of interest on the priced object provider 120. The goods/services provider 120 may the retrieve the priced object from the priced object provider 120 and make a determination as to whether to match, beat, provide a different offer, or do nothing with regard to its offer provided to the client device 108.

As an example of how the present invention may be utilized, assume that a user visits the Web site for a book vendor named BB-Books and finds a book “Favorite Celebrity Childrens' Stories” that is of interest. The user may request information on “Favorite Celebrity Childrens' Stories” including the publication date, price, shipping costs, etc. The user may then decide that he/she is interested in purchasing this book but would like to see if there are better deals on this book from other book vendors.

The user may then request a priced object for “Favorite Celebrity Childrens' Stories.” The priced object may include the ISBN for the book, a price (assume $12.00), and an expiration date for the priced object. The priced object may be generated and stored on the book vendor server, the priced object provider, or the client device, depending on the particular embodiment.

The user may then visit other book vendor Web sites and determine if the book is offered from any of the other Web sites. For example, assume that the user visits the Web site for AA-Books where “Favorite Celebrity Childrens' Stories” is currently being sold for $13.50. The user may elect to inform AA-Books of the existence of the priced object by either sending the priced object to the AA-Books Web site server or informing the Web site server where the priced object may be obtained, e.g., from the priced object provider or the BB-Books Web site server. The server may then obtain the priced object, authenticate it (by decryption or the like), and store the priced object for review by an administrator or other authorized official.

The administrator, or other authorized official, of the AA-Books Web site may then look at the priced object and decide whether to modify AA-Books offer on “Favorite Celebrity Childrens' Stories.” For example, The administrator may decide to sell “Favorite Celebrity Childrens' Stories” to the user for $11.00 in order to obtain the sale. The user may then request a new priced object for the offer of sale of “Favorite Celebrity Childrens' Stories” for $11.00 and the process may be repeated with other book vendors.

While the above embodiments are described in terms of a human administrator making the decision whether to meet, beat or do nothing with regard to the offer of sale of another goods/services provider, the present invention facilitates an automatic mechanism for performing these decision making functions. For example, the goods/services provider server may receive a priced object, authenticate the priced object, and compare the information in the priced object to the information for the selected item. Based on the differences in the terms of the offer in the priced object and the terms of the offer in the selected item information, a rule set associated with the goods/services provider server may be used to determine which terms of the offer to modify and by how much in order to make a competitive bid for the user's business. Such rule sets will of course take into consideration the costs of the selected item as well as the profit margin that a goods/services provider wishes to make off the selected item in order to determine how much the offer terms may be modified.

As mentioned above, the priced object may include an expiration date. The expiration date may be used by administrators of other goods/services providers to determine whether an offer of sale from another goods/services provider is no longer valid or is too remote as to warrant matching the terms of the offer. Alternatively, the goods/services provider servers themselves may make this determination in an automatic fashion by comparing the expiration date to the current date and determining if the difference is more than a predetermined threshold.

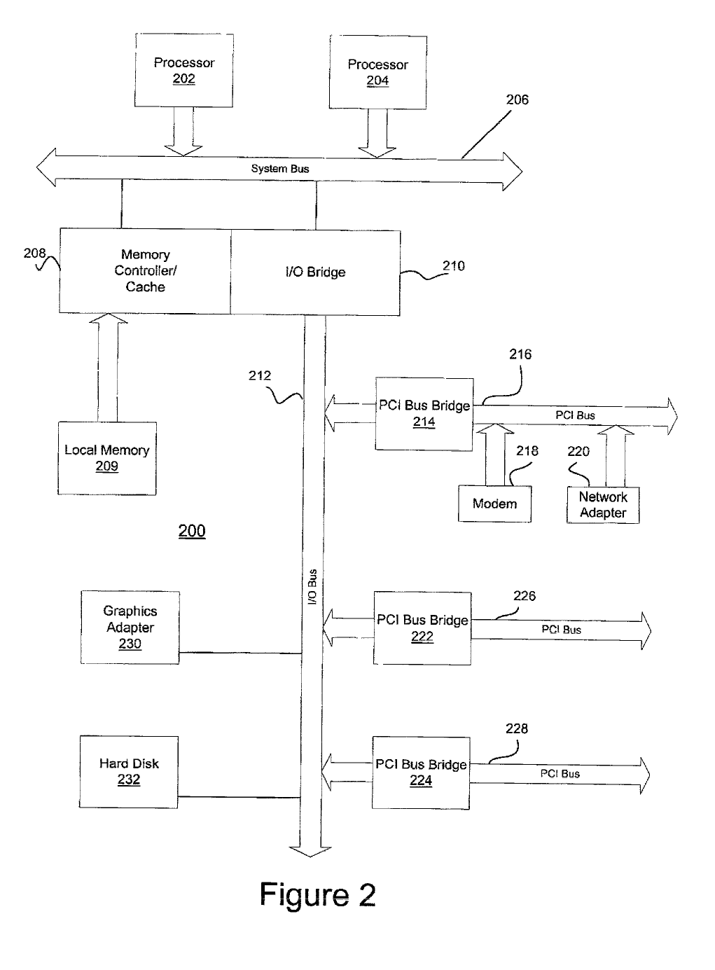

Referring to FIG. 2, a block diagram of a data processing system that may be used to implement the present invention is depicted in accordance with a preferred embodiment of the present invention. The particular data processing system depicted in FIG. 2 represents a server apparatus that may be used to implement the priced object provider 120 of the present invention.

Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to client computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

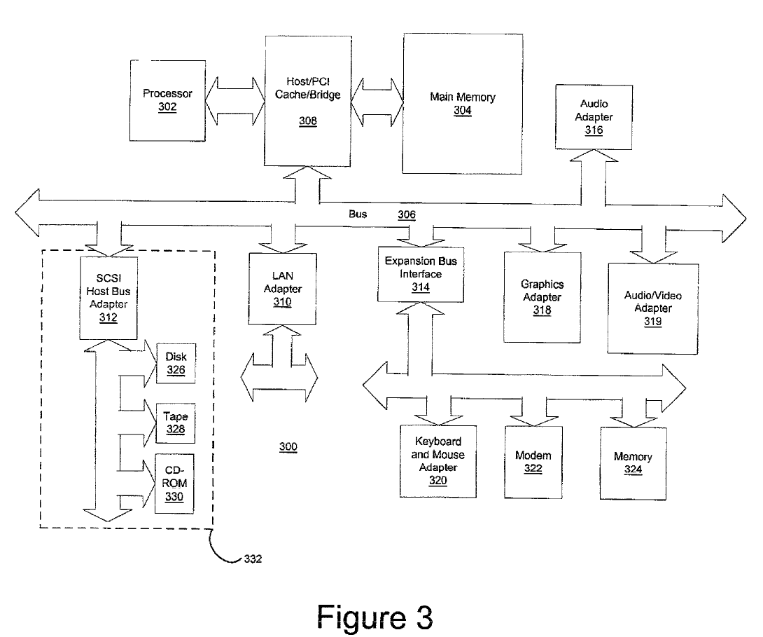

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

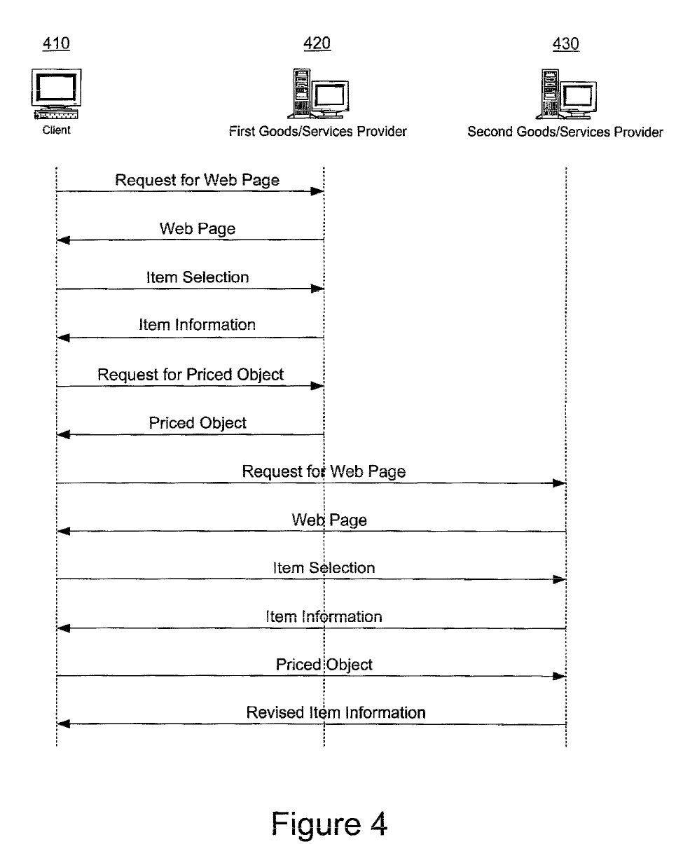

FIG. 4 is an exemplary data flow diagram in accordance with one embodiment of the present invention. As shown in FIG. 4, the data flow starts with a request for a Web page being sent from a client device 410 to a first goods/services provider 420. The first goods/services provider 420 then returns the requested Web page to the client device 410. The user of the client device 410 may then select an item of interest from the requested Web page and transmit the selection to the first goods/services provider 420. In response, the first goods/services provider 420 returns item information for the selected item. The item information may include, for example, the item price, shipping costs, a description of the item, and the like.

If the user of the client device 410 decides that he/she is interested in purchasing the item after reviewing the item information, the user may request a priced object for the selected item. The first goods/services provider 420 may then return a priced object to the client device 410. Alternatively, the priced object may be sent to, or generated by, a third party, such as the priced object provider 120 in FIG. 1.

The user of the client device 410 may then enter address information, such as the URL, for a Web page of a second goods/services provider 430, receive the Web page, select the same item from the Web page of the second goods/services provider 430 as he/she did with the first goods/services provider 420, and obtain item information for the item from the second goods/services provider 430.

The user of the client device 410 may then select an option to transmit the priced object to the second goods/services provider 430 or inform the second goods/services provider 430 as to where the priced object may be found for the selected item. The second goods/services provider 430 may then authenticate the priced object and determine whether to revise the item information for the selected item. For example, the second goods/services provider 430 may determine to lower its price for the item to match or beat the price of the first goods/services provider 430. The revised item information may then be transmitted to the client device 410. The user of the client device 410 may then request a new priced object for the revised item information and the process may be repeated with additional goods/services providers.

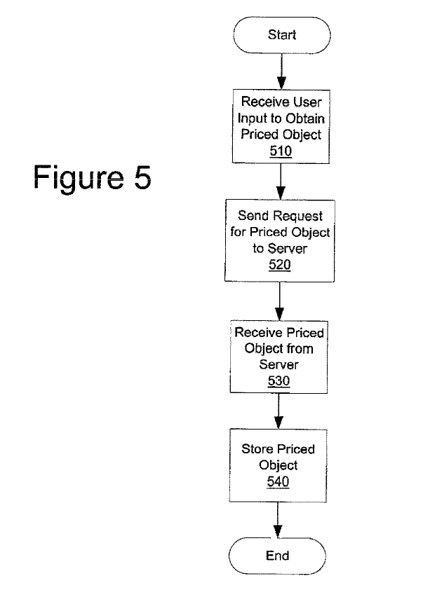

FIG. 5 is a flowchart outlining an exemplary operation of a client device when generating and storing priced object in accordance with the present invention. The operation assumes that the user of the client device has already entered an address for a goods/services provider and obtained a Web page from the goods/services provider. The operation further assumes an embodiment where the priced object is generated by the goods/services provider and sent to the client device. As mentioned above, other embodiments in which the priced object is generated and stored by a third party device, such as the priced object provider 120, or generated and stored on the client device itself, are intended to be within the spirit and scope of the present invention.

As shown in FIG. 5, the operation starts with user input to obtain a priced object being received (step 510). A request is then sent to the goods/services provider server for the priced object (step 520). The priced object is received from the server (step 530) and stored on the client device (step 540). The operation then ends.

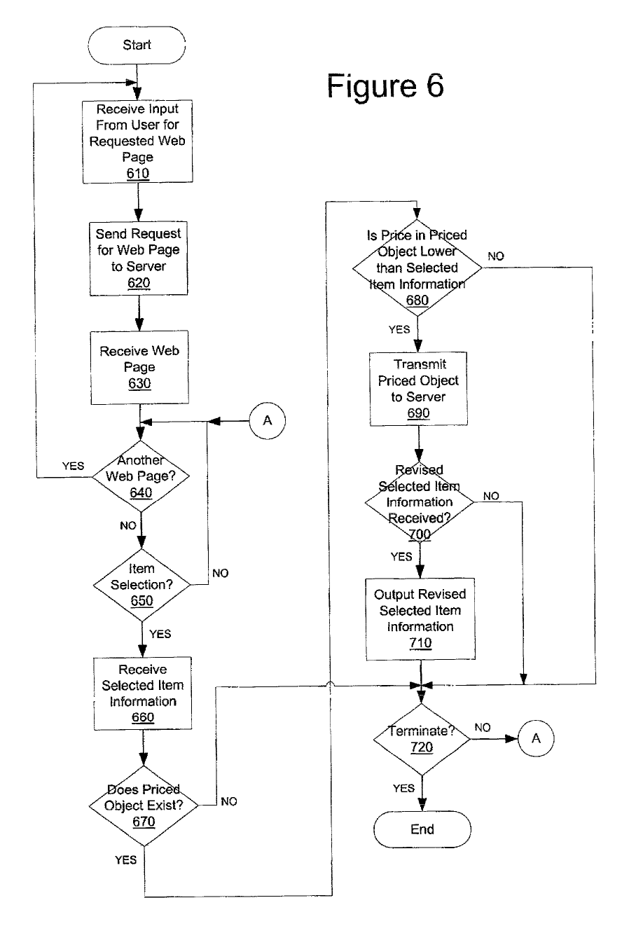

FIG. 6 is a flowchart outlining an operation of a client device when using a previously generated and stored priced object in accordance with the present invention. Again the operation shown in FIG. 6 assumes that the priced object is stored on the client device, although other embodiments of the present invention may be utilized as described above.

As shown in FIG. 6, the operation starts with user input being received for accessing a Web page of a goods/services provider (step 610). A request for a Web page from the goods/services provider server is sent to the goods/services provider server (step 620). The Web page is received (step 630) and a determination is made as to whether the user has input an address for another Web page (step 640). If the user has entered an address for another Web page, the operation returns to step 610. Otherwise, a determination is made as to whether the user has selected an item from the Web page (step 650).

If the user has not selected an item from the Web page, the operation returns to step 640 and awaits input from the user. If the user has selected an item from the Web page, a request is sent to the goods/services provider server for item information and the item information is received from the goods/services provider server (step 660).

A determination is then made as to whether a priced object exists for the selected item (step 670). The determination as to whether a priced object exists may be performed by the user upon review of the item information or it may be performed automatically. For example, the determination may involve comparing a common item identifier, such as an ISBN, in the item information to a common item identifier of stored priced objects. Such automatic determination assumes that the common item identifier in the priced objects is accessible by either not encrypting that portion of the priced object or providing decryption mechanisms for decrypting that portion of the priced object.

If a priced object for the selected item does not exist, the operation goes to step 720 and may terminate. This does not mean that the user's session with the goods/services provider is terminated. On the contrary, the user's session with the goods/services provider may continue and the operation in FIG. 6 may be repeated. However, the operation of the present invention with regard to a priced object for the selected item terminates since there is no priced object for the selected item.

If a priced object does exist for the selected item, a determination is made as to whether the terms of the offer in the priced object, such as price, are lower than the terms of the offer provided in the selected item information (step 680). Again this step may be performed by the user or may be performed automatically by comparing offer terms in the priced object to offer terms in the item information received from the goods/services provider server. The reason that this check is made is because the user does not wish to send a priced object having less desirable terms to a goods/services provider that is providing more desirable terms.

If the terms of the offer in the priced object are better than that in the item information, the priced object is transmitted to the goods/services provider server (step 690). A determination is then made as to whether revised selected item information has been received in response to the sending of the priced object (step 700). If revised selected item information is received, the revised selected item information is output for review by the user (step 710). Otherwise, or if the terms of the priced object has less desirable terms than the selected item information, the operation continues to step 720 where a determination is made whether to terminate operation or not. Such termination may be in response to, for example, a user shutting down the client device web browser application, shutting down the client device, or the like. If the operation is not to terminate, the operation returns to step 640.

Thus, the present invention provides a mechanism by which a user of a client device may cause goods/services provider to bid against one another for selling goods/services to the user. The present invention provides a priced object that can be authenticated by goods/services providers so that they are certain that the terms of the offer described within the priced object are valid terms and not fraudulent. In this way, a user may perform price shopping between electronic business Web sites and give the electronic businesses an opportunity to compete with each other for the user's business.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for identifying an item for purchase, comprising:
receiving a selection of a selected item for sale in a first electronic business;
generating a priced object for the selected item, the priced object describing terms of an offer of sale of the selected item; and
providing the priced object to a second electronic business.

2. The method of claim 1, wherein the second electronic business modifies sale terms for the selected item provided by the second electronic business based on the terms of an offer of sale of the selected item of the priced object.

3. The method of claim 1, wherein the priced object is generated using one of a plug-in device to a web browser, a hyperlink, and an applet.

4. The method of claim 1, further comprising storing the priced object in a storage device associated with the first electronic business.

5. The method of claim 1, further comprising storing the priced object in a storage device associated with a client device.

6. The method of claim 1, further comprising storing the priced object in a storage device associated with a third party device.

7. The method of claim 1, wherein the priced object is generated by a third party device.

8. The method of claim 1, wherein the priced object is generated prior to receiving the selection of the selected item.

9. The method of claim 1, wherein providing the priced object to a second electronic business includes informing the second electronic business of a storage location of the priced object.

10. The method of claim 1, wherein the priced object includes one or more of a commonly recognized item identifier, a price for the item, an expiration date for the priced object, incentives offered by the first electronic business, and an identifier of the first electronic business.

11. The method of claim 1, wherein the priced object includes authentication information for authenticating the priced object as being authorized by the first electronic business.

12. The method of claim 1, wherein the priced object is encrypted.

13. A method of purchasing an item over a data network, comprising:
selecting an item from a first electronic business server Web site;
requesting a priced object for the item;
receiving the priced object; and
transmitting the priced object to a second electronic business server.

14. The method of claim 13, wherein the second electronic business server adjusts terms of sale for the item based on the priced object.

15. A method of performing offer term comparison between a first electronic business and a second electronic business, comprising:
generating a priced object for an item associated with the first electronic business, the priced object including first terms of sale of the item;
providing the priced object to the second electronic business; and
comparing the first terms of sale of the item with second terms of sale of the item associated with the second electronic business.

16. The method of claim 3, further comprising:
modifying the second terms of sale of the item based on the comparison of the first terms of sale with the second terms of sale.

17. An electronic business apparatus for identifying an object for purchase, comprising:
means for receiving a selection of a selected item for sale in a first electronic business;
means for generating a priced object for the selected item, the priced object describing terms of an offer of sale of the selected item; and
means for providing the priced object to a second electronic business.

18. The electronic business apparatus of claim 17, wherein the second electronic business modifies sale terms for the selected item provided by the second electronic business based on the terms of an offer of sale of the selected item of the priced object.

19. The electronic business apparatus of claim 17, wherein the priced object is generated using one of a plug-in device to a web browser, a hyperlink, and an applet.

20. The electronic business apparatus of claim 17, further comprising means for storing the priced object in a storage device associated with the first electronic business.

21. The electronic business apparatus of claim 17, further comprising means for storing the priced object in a storage device associated with a client device.

22. The electronic business apparatus of claim 17, further comprising means for storing the priced object in a storage device associated with a third party device.

23. The electronic business apparatus of claim 17, wherein the priced object is generated by a third party device.

24. The electronic business apparatus of claim 17, wherein the priced object is generated prior to receiving the selection of the selected item.

25. The electronic business apparatus of claim 17, wherein the means for providing the priced object to a second electronic business includes means for informing the second electronic business of a storage location of the priced object.

26. The electronic business apparatus of claim 17, wherein the priced object includes one or more of a commonly recognized item identifier, a price for the item, an expiration date for the priced object, incentives offered by the first electronic business, and an identifier of the first electronic business.

27. The electronic business apparatus of claim 17, wherein the priced object includes authentication information for authenticating the priced object as being authorized by the first electronic business.

28. The electronic business apparatus of claim 17, wherein the priced object is encrypted.

29. A apparatus for purchasing an item over a data network, comprising:
means for selecting an item from a first electronic business server Web site;
means for requesting a priced object for the item;
means for receiving the priced object; and
means for transmitting the priced object to a second electronic business server.

30. The method of claim 29, wherein the second electronic business server adjusts terms of sale for the item based on the priced object.

31. A computer program product in a computer readable medium for identifying an item for purchase, comprising:
first instructions for receiving a selection of a selected item for sale in a first electronic business;
second instructions for generating a priced object for the selected item, the priced object describing terms of an offer of sale of the selected item; and
third instructions for providing the priced object to a second electronic business.

32. The computer program product of claim 31, wherein the second electronic business modifies sale terms for the selected item provided by the second electronic business based on the terms of an offer of sale of the selected item of the priced object.

33. The computer program product of claim 31, wherein the second instructions include instructions for using one of a plug-in device to a web browser, a hyperlink, and an applet.

34. The computer program product of claim 31, further comprising fourth instructions for storing the priced object in a storage device associated with the first electronic business.

35. The computer program product of claim 31, further comprising fourth instructions for storing the priced object in a storage device associated with a client device.

36. The computer program product of claim 31, further comprising fourth instructions for storing the priced object in a storage device associated with a third party device.

37. The computer program product of claim 31, wherein the second instructions are executed prior to the first instructions.

38. The computer program product of claim 31, wherein the third instructions include instructions for informing the second electronic business of a storage location of the priced object.

39. The computer program product of claim 31, wherein the priced object includes one or more of a commonly recognized item identifier, a price for the item, an expiration date for the priced object, incentives offered by the first electronic business, and an identifier of the first electronic business.

40. The computer program product of claim 31, wherein the priced object includes authentication information for authenticating the priced object as being authorized by the first electronic business.

41. The method of claim 31, further comprising fourth instructions for encrypting the priced object.

42. A computer program product in a computer readable medium for purchasing an item over a data network, comprising:
first instructions for selecting an item from a first electronic business server Web site;
second instructions for requesting a priced object for the item;
third instructions for receiving the priced object; and
fourth instructions for transmitting the priced object to a second electronic business server.

43. The computer program product of claim 42, wherein the second electronic business server adjusts terms of sale for the item based on the priced object.
